(19) United States
(12) Patent Application Publication
(10) Pub. No.: US 2016/0086104 A1
(43) Pub. Date: Mar. 24, 2016

(54) FACILITATING INTELLIGENT GATHERING OF DATA AND DYNAMIC SETTING OF EVENT EXPECTATIONS FOR EVENT INVITEES ON COMPUTING DEVICES

(71) Applicants: RITA HANNA WOUHAYBI, Portland, OR (US); JOHN C. WEAST, Portland, OR (US); ADAM CLAY JORDAN, Berkeley, CA (US); JOSHUA J. RATLIFF, San Jose, CA (US); LAMA NACHMAN, San Francisco, CA (US)

(72) Inventors: RITA HANNA WOUHAYBI, Portland, OR (US); JOHN C. WEAST, Portland, OR (US); ADAM CLAY JORDAN, Berkeley, CA (US); JOSHUA J. RATLIFF, San Jose, CA (US); LAMA NACHMAN, San Francisco, CA (US)

(21) Appl. No.: 14/491,718

(22) Filed: Sep. 19, 2014

(51) Int. Cl. G06Q 10/02; G06Q 50/00; G06Q 10/10

(52) U.S. Cl. CPC G06Q 10/02; G06Q 10/1095; G06Q 50/01

(57) ABSTRACT

A mechanism is described for facilitating data gathering and expectations setting according to one embodiment. A method of embodiments, as described herein, includes detecting an invitation relating to an event, where the invitation may include an invitation to an invitee to attend the event. The method may further include obtaining data relating to the event from a plurality of sources, where the data further relates to other invitees of the event. The method may further include interpreting the obtained data based on one or more of filtering factors and relevancy factors, generating recommendations based on the interpreted data, where the recommendations may include expectations relating to the event. The method may further include facilitating communication of the recommendations to set the expectations for the invitee in anticipation of the event.

### FIELD

Embodiments described herein generally relate to computers. More particularly, embodiments relate to facilitating intelligent gathering of data and dynamic setting of event expectations for event invitees on computing devices.

### BACKGROUND

With the increasing use of computing device, there has been a corresponding rise in communicating electronic invitations to various events, ranging from informal parties to formal conference. However, none of the conventional techniques facilitating these invitations are intelligent enough in terms of providing an attendee a real sense of other attendees, venue restraints, dress code, etc., which can often leave the attendee in an awkward or unpleasant spot, such us missing out on the dress code.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a data gathering and event expectation setting mechanism according to one embodiment.

FIG. 2 illustrates a data gathering and event expectation setting mechanism according to one embodiment.

FIG. 3A illustrates a transaction sequence for facilitating gathering of data and setting of expectations relating to an event at computing devices according to one embodiment.

FIG. 3B illustrates a method for facilitating gathering of data and setting of expectations relating to an event at computing devices according to one embodiment.

FIG. 4 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiment provide for intelligent gathering or collecting of data, such as both publicly and privately available data, for dynamically setting event expectations for users, such as event personnel including one or more invitees, one or more event organizers, etc. Embodiments provide for a bi-directional communication of event expectations where, for example, if event organizer sees that all or most invitees are planning on wearing a bit more formal attire than the event organizer had anticipated, then the event organizer may accordingly adjust decorations, decorum, music, etc., to match the invitees' attire. For brevity, the term “user” may be used throughout the document to include invitees as well as event organizers, etc. In one embodiment, setting user expectations may include providing the user any recommendations relating to an event prior to the event, such as providing the user (e.g., invitee) information/recommendations relating to one or more of clothing, venue/location, weather, list of other invitees and/or previous attendees, expectation of behavior of invitees and/or previous attendees (e.g., gender, ethnicity, age, professional classification, etc.), etc., regarding an upcoming event to which the user has been invited. As will be further described in this document, the public/private data may include any amount and type of data (such as photos (e.g., user photos, other invitee photos, previous event photos, etc.), text messages, publicly-available descriptions (e.g., weather expectations, event description provided by the event organizers, public blogs about the event, etc.), privately-available information (e.g., user inputs, user's calendar, user's computer, company intranet, social/business networking websites of the user and other invitees, etc.)) that is gathered or collected from any number and type of data sources (e.g., venue website, city website, event website, weather website, social/business networking websites (e.g., Facebook®, Twitter®, LinkedIn®, etc.), etc. It is to be noted that terms “gather”, “collect”, and “obtain” and any variations of these terms, such as “gathering”, “collecting”, “obtaining”, “gathered”, “collected”, “obtained”, “gathers”, “collects”, “obtains”, and the like, may be interchangeably referenced throughout this document.

Embodiments further provide for specific preferences, such as relating to clothing, etc., based on user inputs (e.g., user's preference of the type or brand of clothes, clothes that the user owns, user's preferred store, fashion of someone the person knows or a celebrity the user follows, etc.) as provided by the user in any number and type of manners, such as by simply typing in the relevant information, submitting photos, scanning receipts, etc. Similarly, such specific recommendations may also be based on various sales or advertisements provided by participating vendors as will be further discussed in this document.

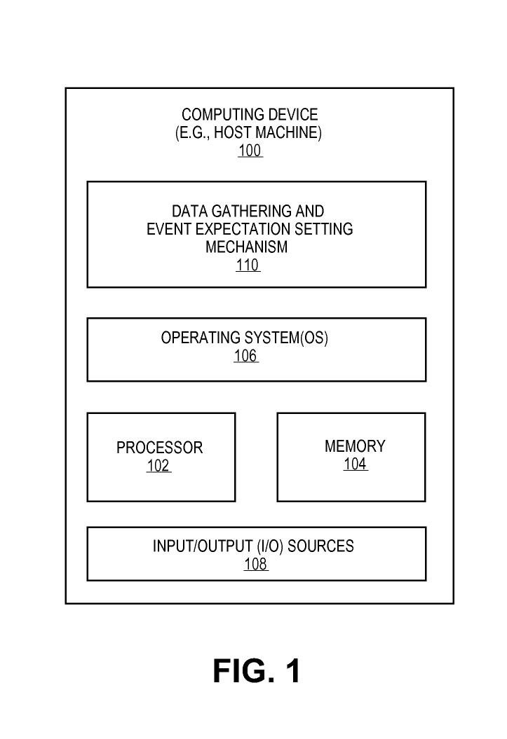

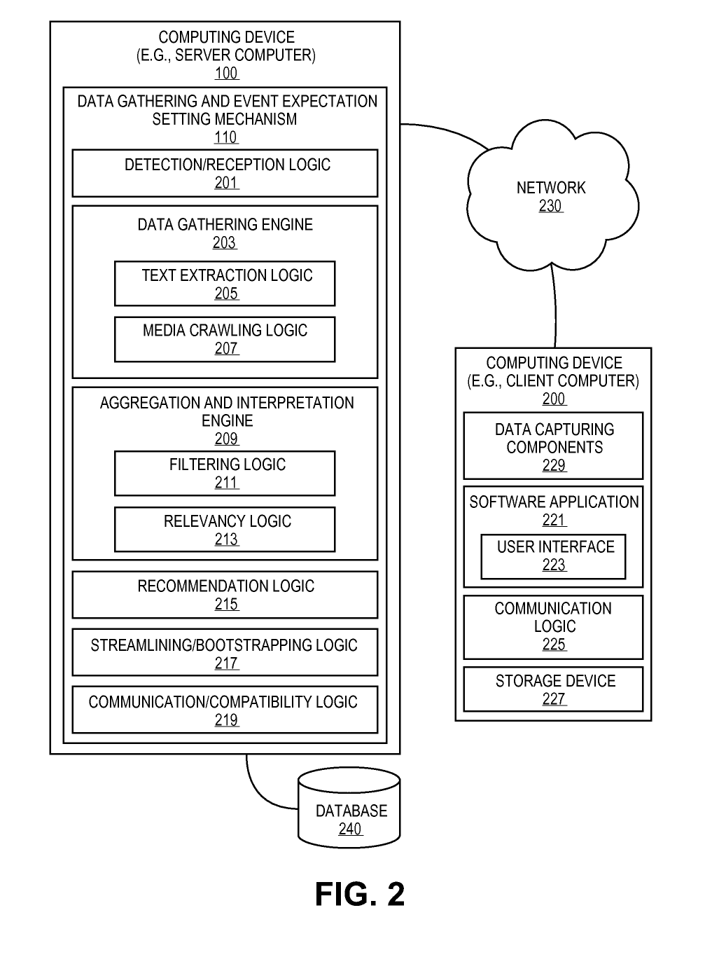

FIG. 1 illustrates a data gathering and event expectation setting mechanism 110 according to one embodiment. Computing device 100 serves as a host machine for hosting a data gathering and event expectation setting mechanism 110 (“event mechanism”) 110 that includes any number and type of components, as illustrated in FIG. 2, to efficiently perform intelligent gathering of data and dynamic setting of event expectations for users, such as event invitees, as will be further described throughout this document.

It is contemplated that the term “user” may refer to or include an individual or a group of individuals regarded as invitee(s) to one or more new or continuing events, event organizers of one or more new or continuing events, etc., but that in some embodiments, the term “user” may also refer to or include an attendee or a group of attendees if the event has already started and is being attended by the user. For example, in some case, an event may be an extended event that includes multiple sub-events and/or is conducted over multiple days and includes various activities with different types and levels of attendees (such as a business trip or a multi-day conference that includes a meeting with the management, another meeting with the staff, a presentation to a potential client, etc., and other activities, such as dinner, golfing, fishing, hiking, etc.). However, for brevity, clarity, and ease of understanding, throughout the document, the term “user” may be referred to as a single invitee, but it is to be noted that embodiments are not limited as such to invitees or merely a single invitee and that embodiments are applicable to one or more invitees, one or more attendees, and any number, type, and size of events, sub-events, multi-events, etc.

Computing device 100 may include any number and type of communication devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones (e.g., iPhone® by Apple®, BlackBerry® by Research in Motion®, etc.), personal digital assistants (PDAs), tablet computers (e.g., iPad® by Apple®, Galaxy 3® by Samsung®, etc.), laptop computers (e.g., notebook, netbook, Ultrabook™ system, etc.), e-readers (e.g., Kindle® by Amazon®, Nook® by Barnes and Nobles®, etc.), media internet devices (“MIDs”), smart televisions, television platforms, wearable devices (e.g., watch, bracelet, smartcard, jewelry, clothing items, etc.), media players, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

FIG. 2 illustrates a data gathering and event expectation setting mechanism 110 according to one embodiment. In one embodiment, computing device 100 may serve as a host machine for hosting event mechanism 110 that includes any number and type of components, such as: detection/reception logic 201; data gathering engine 203 including text extraction logic 205 and media crawling logic 207; aggregation and interpretation engine 209 including filtration logic 211 and relevancy logic 213; recommendation logic 215; streamlining/bootstrapping logic 217; and communication/compatibility logic 219. Computing device 100 may be in communication with database 240 where any amount and type of gathered data along with any amount and type of data sources, such as resources, policies, etc., may be stored.

In the illustrated embodiment, computing device 100 serves as a server computer hosting event mechanism 110 while serving and staying in communication with any number and type of client computing devices, such as computing device 200 (e.g., desktop computer, laptop computer, mobile computing device, such as a smartphone, a tablet computer, etc.) over one or more networks, such as network 230 (e.g., cloud network, the Internet, intranet, proximity network, Bluetooth, etc.).

In the illustrated embodiment, computing device 100 is shown as hosting event mechanism 110; however, it is contemplated that embodiments are not limited as such and that in another embodiment, event mechanism 110 may be hosted entirely by a client computing device, such as computing device 240, or, in yet another embodiment, event mechanism 110 may be entirely or partially hosted by both server and client computing devices, such as one or more components of event mechanism 110 may be hosted by computing device 100 while one or more components of event mechanism 110 may be hosted by computing device 240. However, throughout this document, for the sake of brevity, clarity, and ease of understanding, expectations mechanism 100 is shown as being hosted by computing device 100.

Computing device 240 may include one or more software applications, such as software application 221 (e.g., website, business application, mobile device application, etc.), associated and in communication with event mechanism 110 to allow for client-based tasks to facilitate the overall functionalities and services of event mechanism 110. In one embodiment, software application 221 may offer one or more user interfaces, such as user interface 223 (e.g., web user interface (WUI), graphical user interface (GUI), touchscreen, etc.), to allow the user having access to computing device 240 to be able to access event mechanism 110 and receive its various functionalities and services, such as registering for event mechanism 110, sending and receiving invitations and event expectations through event mechanism 110, inputting user preferences, etc., through user interface 223. User interface 223 may be provided via a display component, such as display device, display screen, etc., that may be part of or in communication with computing device 240. Computing device 240 is further shown to include communication logic 225 and storage medium 227.

Computing device 240 may include one or more data capturing components 229 that can be used for capturing any amount and type of data, such as images (e.g., photos, videos, etc.), audio streams, biometric readings, environmental/weather conditions, maps, etc., which may be gathered by gathering engine 201. It is contemplated that embodiments are not limited to any amount or particular types of components or forms of data capable of being captured by such components 229; however, as examples and for the sake of brevity, such components 229 may include (without limitation) audio/visual devices (e.g., cameras, microphones, speakers, etc.), context-aware sensors (such as temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device, etc.), global positioning system (“GPS”) sensors, resource requestor, and trusted execution environment (TEE) logic. TEE logic may be employed separately or be part of resource requestor and/or an I/O subsystem, etc.

Suppose that an invitation to an event is received by a number of users (e.g., invitees) including a user (e.g., invitee) of computing device 240. Upon communication of the invitation from one or more computing devices to computing device 240, it may be detected or a copy of which may be received or extracted by detection/reception logic 201 of event mechanism 110 at computing device 100. Upon detection or reception or extraction of the invention by detection/reception logic 201, data gathering engine 203 may be triggered. In one embodiment, text extraction logic 205 of data gathering engine 205 may be triggered to gather as much text as available relating to the event and its invitees.

In one embodiment, the event and user's participation in the event may be inferred by monitoring the user's media feeds such that the user may not even need a formal invitation or make a specific request to receive recommendations from event mechanism 110. Similarly, in one embodiment, various invitation websites, such as Evite®, etc., may employ event mechanism 110 such that any recommendations (as well as all the logic behind various processes leading up to the recommendations) may occur, via event mechanism 110, prior to the announcement of the event in the first place with an average recommendation for all users.

In one embodiment, text extraction logic 205 may access any number and type of online sources, such as one or more event or event sponsors' websites, weather websites, hotel websites, venue websites, city websites, users' websites, company/business websites, social/business networking websites (e.g., Facebook®, Twitter®, LinkedIn®, etc.), and the like, to extract as much textual information as available about the event, the weather, the venue, the city, and the like. For example, in accessing the event website or other relevant websites (such as a website listing a blog about the event, a news website discussing or announcing the event, a social website listing historical events relating to the same or similar events of the past (e.g., the same winter charity ball or a similar charity gave a winter charity ball in the past, etc.) may be accessed by text extraction logic 205 to gather any verbiage relating to dress code, local culture regarding clothing, invitee demographics (e.g., age, ethnicity, age, professional classification, etc.), food type, etc. Similarly, such websites (e.g., event website) may be accessed to gather any information that text extraction logic 205 may find relating to the event and/or the invitees as described above.

In one embodiment, upon detection of the invitation, media crawling logic 207 may also be triggered for gathering of image data from various sources. In one embodiment, media crawling logic 207 may work simultaneously or in parallel with text extraction logic 205 or, in another embodiment, media crawling logic 207 may begin gathering before or after text extraction logic 205 has initiated its task. For example, in one embodiment, any data gathered by text extraction logic 205 may then be forwarded on to media crawling logic 207 to access a variety of sources to extract any number and type of media (e.g., videos, images, photos, sketches, prints, audios, audio/videos, etc.) to not only extract additional media-based data, but also, in some cases, to make better sense of the text-based data gathered by text extraction logic 205.

With the increase in use of computing devices (e.g., mobile computing devices) and social media, more and more users are frequently posting a large number new and old photos, videos, audios, etc., on various social/business networking sites. Taking advantage of this trend, media crawling logic 207 may access a variety of websites, such as one or more event or event sponsors' websites, weather websites, hotel websites, venue websites, city websites, users' websites, company/business websites, etc., along with one or more social/business networking websites (e.g., Facebook®, Twitter®, LinkedIn®, Google+®, Picasa®, etc.), etc., to extract any number and type of media relating to the event and the invitees. For example, one or more videos and photos relating to a multi-day event (e.g., festival, multi-day convention, etc., where, for example, the first day or two of the same events) may be gathered showing the expected dress code, formal/informal way of communication between attendees, attendee demographics, food type, venue lighting, etc.

As aforementioned, given the increasing use of social media, the likelihood of finding media relating to similar events previously conducted is rather high and further, media crawling logic 207 may use the textual features extracted by text extraction logic 205 to run targeted and specific searches for media. For example, a search may be based on a specific vocabulary or keyword (e.g., dinner attire, hiking trail, etc.) so that targeted media, such as photos, may be searched and then, in some embodiments, the extracted photos may be tagged with the search keywords (e.g., dinner attire, hiking trail, etc.) for subsequent processing. In some embodiments, GPS sensors may be used to track the exact location of where the event (e.g., workshop, conference, tradeshow, convention, etc.) is to be conducted (such as based on the events from previous years, etc.) and this local information may then be used to obtain specific and targeted photos relating to the venue, venue neighborhood, local weather, nearby hotels and their star ratings, etc.

It is to be noted that in addition to accessing various sources for relevant data (e.g., text, media, etc.) as described above, in one embodiment, any amount of the relevant data may also be obtained directly from the information provided by the user. Stated differently, in one embodiment, the relevant data may include a combination of gathered data from various sources, as stated above, and data that is user-driven or user-provided so that any final event settings or recommendations may be closely customized based on the information provided by the user. For example, as aforementioned, the user may use user interface 223 of software application 221 to input certain information, such as pictures and/or videos from previous or other similar events, pictures and/or videos of clothing the user owns, etc., or the user may choose to simply type in the information relating to the user's preference in style of or brand name clothing, shoes, airlines, class of airline tickets, hotels, etc.

In one embodiment, user inputs having user information and preferences may be provided to event mechanism 110 in any number of ways (e.g., via media, such as photos, videos, images, etc.) in order to create, populate, and/or update a user profile. For example, the user may choose to use one of data capturing components 229, such as a camera, to take the latest photos and/or videos of the user's preferred celebrity, clothes, shoes, jewelry, the entire wardrobe, shopping receipts, a selfie to convey the user's style wearing a particular suit, etc., which may then be submitted via user interface 223 of software application 221 and communicated to event mechanism 110 via communication logic 225 and communication/compatibility logic 219 over network 230 (e.g., cloud network). Similarly, for example, the user may choose the already-saved media from one or more of the user's social networking websites, emails, hard-drive or storage medium 227, etc., which may then be communicated to event mechanism 110.

In yet another embodiment, the user may choose to scan in any number and type of documents containing the aforementioned relevant information, such as scanning in receipts of purchased/owned clothing, taxi receipts, hotel receipts, travel itineraries, ball game tickets, etc., to convey the relevant information about what the user owns and/or prefers so that the relevant information may be used for further processing. This scanning in of the documents may be performed by the user through a scanner of data capturing components 229 and submitted via user interface 223 of software application 221 and communicated to event mechanism 110 over network 230. Further, this may be connected to the user profile information that may exist with different online accounts (e.g., Google®, etc.) or commercial market profile companies (e.g., Nexus-Lexus®, etc.) such that the incorporation of what the user owns and prefers can be automatic and thus need not be manual.

In yet another embodiment, the user may choose to select and provide one or more names of individuals (e.g., regular individuals, celebrities, etc.) that the user knows or prefers, such as names of relatives or friends of the user, celebrities the user prefers (e.g., actors, politicians, athletes, etc.), so that the individuals' styles may be closely followed and their relevant data may be extracted by data gathering engine 203 and used for further processing at later stages, as described below, for generating properly calibrated event recommendations for the user.

Embodiments further provide for involving various vendors (also referred to as “merchants”, “retailers”, “sellers”, etc.) to get involved in the process for marking or advertisement purposes. In one embodiment, any number and type of vendors may be invited to participate in providing their relevant services through event mechanism 110. For example, one or more vendors (e.g., Saks Fifth Ave®, Macy's®, etc.) may be integrated into the system where the one or more vendors may participate in offering their own products (e.g., clothing apparel, shoes, jewelry, watches, gifts, etc.) or services (e.g., limousines, manicures, haircuts, etc.) to be in line with user preferences, user shopping history at those vendors, etc., and needs based on the gathered and/or user-inputted data. Further, for example, one or more vendors may offer their products or services as an alternative to what might be recommended based on the gathered and/or user-inputted data when such recommendations may not be fulfilled (such as a particular type of coat is not available, etc.) and/or are disliked or rejected by the user.

As aforementioned, in one embodiment, any amount of user data may be directly accessed at and obtained from various sources (as opposed to being inputted by the user), such as by accessing the user's social network websites, hard drive or storage medium 227, emails, etc., by text extraction logic 205 and media crawling logic 207 of data gathering engine 203, without having the user to input any amount of that data.

In one embodiment, once the gathered and/or user-inputted data (e.g., text, media, etc.) has been obtained, it may then be forwarded on to aggregation and interpretation engine 209 for further processing. Upon receiving the relevant data at aggregation and interpretation engine 209, in one embodiment, filtering logic 211 may be triggered to evaluate and filter out any unnecessary or irrelevant elements from the relevant data. In one embodiment, filtering logic 211 may evaluate the gathered and/or user-inputted data based on any number and type of factors, such as privacy, decency, legality, amount of data, general relevancy, etc.

For example, filtering logic 211 may determine whether there are protocols being violated by any of the contents of the gathered and/or user-inputted data, such as whether the contents contain (without limitations): any names, photos, videos, etc., of random or particular individuals, residential or certain irrelevant commercial addresses; indecent or illegal images (e.g., nudity, banned organizations' logos, invitations to illegal acts, etc.); too much data that can be overwhelming for viewing by the user; and generally irrelevant messages, images, videos, etc. (such as images from an irrelevant country/climate (e.g., event images from Norway in December, but the upcoming event is in Colombia in July, etc.), or from a totally different type of event (e.g., wedding pictures, but the upcoming event is a business conference), etc.), etc., and such contents may then be removed from the gathered and/or user-inputted data by filtering logic 211.

Once filtering logic 211 has completed its tasks, the remainder of the gathered and/or user-inputted data is the forwarded on to relevancy logic 213 for further streamlining and calibrating of data based on additional and more specific relevancy factors. In one embodiment, relevancy logic 213 may evaluate and streamline the remainder of the gathered and/or user-inputted data based on any number and type of factors having relevancy to the event, the user and other invitees, location, etc., such as (but not limited to): date; time of day (this being of value for various venues, such as those being kid-friendly during the day, but adult-only after a certain hour of the day and thus, for example, if an image does not have the appropriate data, then, in one embodiment, the image may be removed but, in another embodiment, various imaging techniques may be used for the time that includes light types, lighting used if indoors, etc.); context (e.g., parties with alcohol, kids events, sports events, professional conference, etc., as these can be extracted from metadata and visual clues, etc.); attendees (e.g., crowd size, demographic information, such as age, gender, ethnicity, nationality, etc.); clothing factors (e.g., expensive, colors, formal or informal or business-casual, etc.); weather, etc.

In one embodiment, relevancy logic 213 may also assign relevance or weighted scores (e.g., numerical scores (such as 10 being high, 1 being low), alphabetic scores (such as A being high, F being low), symbolic scores (such as 5 stars being high, half a star being low), etc.) may be assigned to various parts or contents of the data to generate a list of weighted arrogated keywords, etc. For example, certain keywords may be of greater importance (temporarily or permanently, etc.) than other keywords, such keyword “rain” may carry a higher importance during raining season or when it is expected to rain during the event. Similarly, certain keywords may carry higher weight if they reflect the user's preference, such as a brand name for suit, dress, cologne, purse, hotel, airline, etc. These weights are assigned so that they may be forwarded on to recommendation logic 215 for consideration and further processing.

Upon processing by aggregation and interpretation engine 209, the processed and relevant gathered and/or user-inputted data along with its associated weighted scores is then forwarded on to recommendation logic 215 for further processing. At recommendation logic 215, the relevant gathered and/or user-inputted data and the corresponding weighted scores are further evaluated so that appropriate and calibrated recommendations may be generated and presented to the user.

In one embodiment, recommendation logic 215 evaluates the received data and is intelligent enough that it may choose to re-assesses the received data using one or more of the aforementioned relevancy factors, as mentioned above, and/or certain factors that may have come to light only recently, such as recent changes in the weather or political situation of the country where the event is being held, a new fashion trend, a one-time change or a recent act by the user or one or more of the user's chosen personalities (e.g., individual, such as a celebrity, followed by the user) that suggests that a particular recommendation might not be approved by the user, etc. In one embodiment, recommendation logic 215 forms a set of recommendations for the user relating to the event based on the evaluation and processing performed by recommendation logic 215 and those previously performed by various other components of event mechanism 110. Stated differently, the recommendations are dynamically altered or modified in light of any number of factors.

Although optional, the recommendations may be re-considered by streamlining/bootstrapping logic 217 to further enhance user confidence in event recommendations so that even better potential event expectations may be set for the user. Stated differently, the recommendations may be further streamlined in light of any new communication data that may have been recently obtained and/or may not have been previously considered so that any event expectation based the recommendations may be further calibrated. In one embodiment, it is contemplated that the event may still be some time away and meanwhile, the user may choose to communicate with other invitees (e.g., directly with individuals via email, texting, telephone call, etc., or indirectly through Facebook® pages, independent blogs, event website discussions, such as donors comments at a charity website for a charity event, etc.) in order to obtain a mutual understanding about certain dynamics of the event, such as what other invitees are planning on wearing, will there be any discussion about the passing of a certain colleague, will there be any side events, such as informal get-togethers or running/hiking trips, etc.

It is contemplated that such communication data or comments may be obtained on a periodic basis over a period of time before the event and continue to change as new information is gathered and therefore, in one embodiment, streamlining/bootstrapping logic 217 may take such communication data into consideration and propose to alter one or more recommendations as necessary or appropriate. This information may then be communicated back to recommendation logic 215 which may accept or reject the proposal by streamlining/bootstrapping logic 217. In case of acceptance, recommendation logic 215 may generate new or updated recommendations, based on the proposal, to be communicated back to the user via computing device 200. In case of rejection, the previously-generated recommendations may be maintained as they remain communicated to the user via computing device 200.

It is contemplated that the user's communication with other users (e.g., invitees) at other computing devices may be facilitated via communication logic 225 over one or more networks, such as network 230. For example, the user may choose to communication with other users via email using one or more email applications (e.g., Gmail®, Outlook®, company-based email, etc.), text or phone using one or more telecommunication applications (e.g., Skype®, Tango®, Viber®, default text application, etc.), social networking websites (e.g., Facebook®, Twitter®, LinkedIn®, etc.), or the like.

In one embodiment, once the recommendations have been formed and streamlined, they may then be communicated back to the user via software application 221 at computing device 200 over network 230. As discussed throughout the document, such recommendations may be regarded as setting expectations for the user about the event and its invitees. In one embodiment, these recommendations and all other data relating to these recommendations, such as the gathered and/or user-inputted data collected over a period of time, user preferences, rules and policies, etc., may be stored at one or more databases, such as database 240, so any contents of which may accessed as necessitated or desired. Similarly, it is contemplated that the recommendations, once received at computing device 200, and much of the other user-inputted data may be stored at storage device 227 at computing device 200 so that it may then be accessed by the user or event mechanism 110 as necessitated or desired.

Communication/compatibility logic 219 may be used to facilitate dynamic communication and compatibility between computing device 100 and any number and type of other computing devices 200 (such as mobile computing device, desktop computer, server computing device, etc.), processing devices (such as central processing unit (CPU), graphics processing unit (GPU), etc.), data capturing components 229 (such as camera, biometric sensor, etc.), display elements (such as a display device, display screen, etc.), user/context-awareness components and/or identification/verification sensors/devices (such as biometric sensor/detector, scanner, etc.), memory or storage devices, databases and/or data sources (such as data storage device, hard drive, solid-state drive, hard disk, memory card or device, memory circuit, etc.), networks (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, such as Facebook®, LinkedIn®, Google+®, Twitter®, etc., business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “point”, “tool”, and the like, may be referenced interchangeably and include, by way of example, software, hardware, and/or any combination of software and hardware, such as firmware. Further, any use of a particular brand, word, term, phrase, name, and/or acronym, such as “gathering”, “gathered data”, “crawling”, “extracting”, “recommendation”, “expectation”, “bootstrapping”, “streamlining”, “event”, “invitee”, “attendee”, “text” or “textual”, “photo” or “image”, “video”, “audio”, “social networking website”, “logic”, “engine”, “module”, etc., should not be read to limit embodiments to software or devices that carry that label in products or in literature external to this document.

It is contemplated that any number and type of components may be added to and/or removed from event mechanism 110 to facilitate various embodiments including adding, removing, and/or enhancing certain features. For brevity, clarity, and ease of understanding of event mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

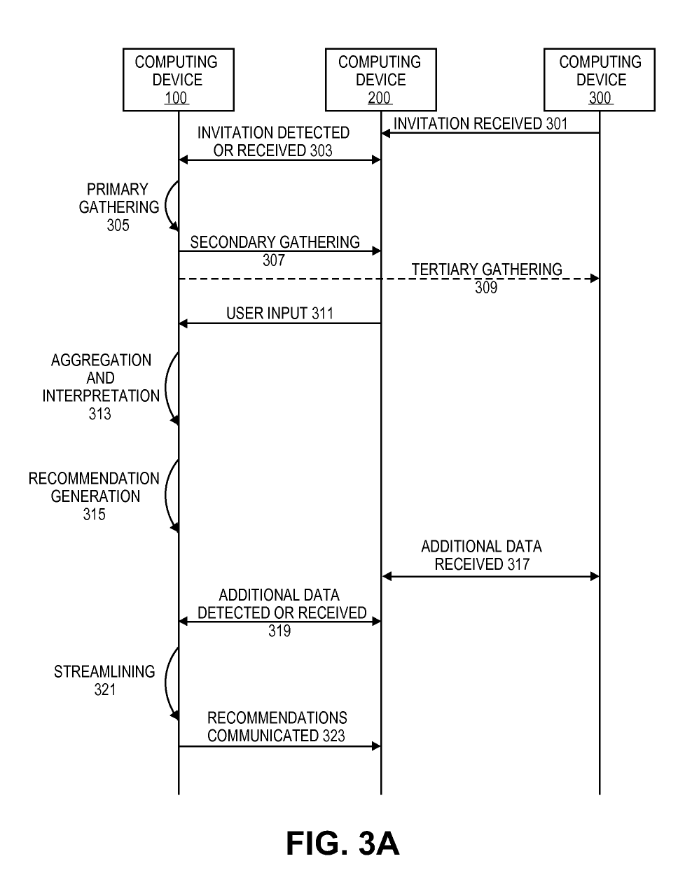

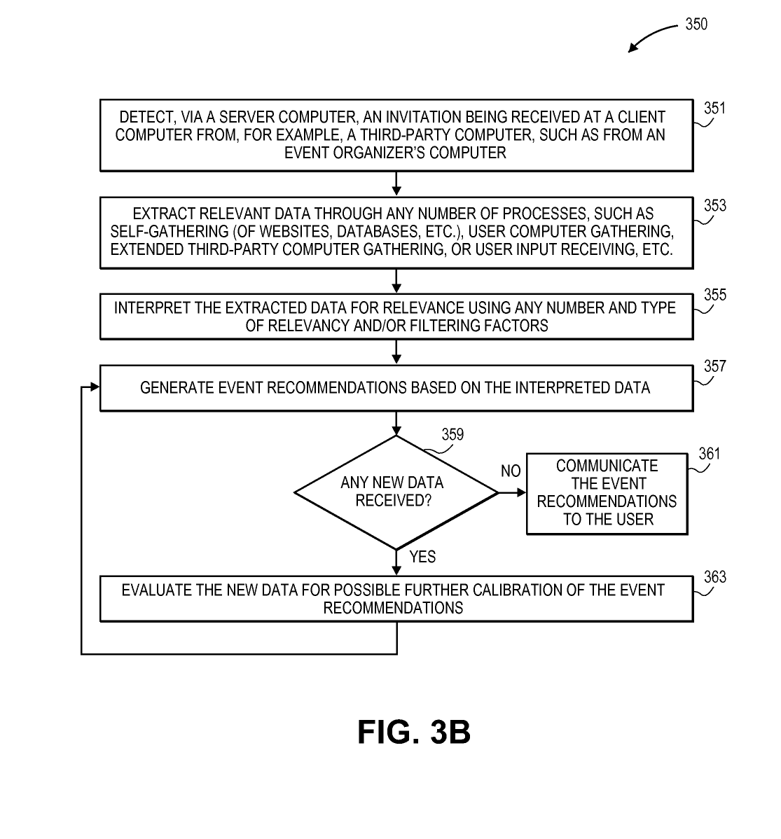

FIG. 3A illustrates a transaction sequence 300 for facilitating gathering of data and setting of expectations relating to an event at computing devices according to one embodiment. Transaction sequence 300 may be performed by processing logic that may comprise hardware (e.g., circuitry, dedicated logic, programmable logic, etc.), software (such as instructions run on a processing device), or a combination thereof. In one embodiment, transaction sequence 300 may be performed by event mechanism 110 of FIG. 1. The processes of transaction sequence 300 are illustrated in linear sequences for brevity and clarity in presentation; however, it is contemplated that any number of them can be performed in parallel, asynchronously, or in different orders. For brevity, many of the details discussed with reference to FIGS. 1 and 2 may not be discussed or repeated hereafter.

In one embodiment, transaction sequence 300 begins with computing device 200 (e.g., mobile client computer, such as a smartphone, a tablet computer, etc.) receiving an invitation 301 to an event from one or more computing devices 300 (e.g., third-party server computers, other client computers, etc.). For example, the invitation to the event may be from an event organizer at a computing device 300 for a user (e.g., invitee) at computing device 200. Once the invitation is received 301 at computing device 200, it may then be communicated 303 to computing device 100 (e.g., server computer) or automatically detected 303 by computing device 100 that may be hosting event mechanism 110 of FIG. 1.

Upon receiving or detecting the invitation 303, a gathering of data 305, 307, 309 is triggered as is further described with reference to FIG. 2. In one embodiment, data gathering may include primary data gathering 305 where data gathering engine 203 of FIG. 2 seeks any relevant data at a local database, such as database 240 of FIG. 2, or via any number and type of other sources, such as social networking websites, event websites, event blogs, news websites, weather websites, etc., as discussed with reference to FIG. 2. Similarly, in another embodiment, data gathering may include secondary data gathering 307 where any amount and type of data may be gathered via one or more client computing devices, such as computing device 200, belong to the user and, in yet another embodiment, tertiary data gathering 309 may be performed such that any amount and type of data may be gathered at other computing devices 300 (e.g., company-authorized computers or databases, other authorized client computers or databases belonging to other invitees, public computers, etc.). Furthermore, in yet another embodiment, any amount and type of data may be received via user input 311 where the user may choose to input any amount and type of information, preferences, etc., that may then be considered for forming event recommendations.

In one embodiment, the gathered or received data may then be aggregated and interpreted 313 by aggregation and interpretation engine 209 of FIG. 2. This interpreted data may then be used by recommendation logic 215 of FIG. 2 to form event recommendations 315 for the user. It is contemplated that in some cases, the user may choose to communicate with other invitees or even non-invitees regarding the event and such communication may produce additional data 317. This additional data may then be gathered by or received (via event mechanism 110 of FIG. 2) at computing device 100 to be further considered by streamlining/bootstrapping logic 217 of FIG. 2. Upon considering of this additional data, recommendation logic 215 of FIG. 2 may be re-triggered to further calibrate and/or re-generate any number of event recommendations which are then communicated 323 to the user at computing device 200. In one embodiment, an initial set of event recommendations may be communicated to the user without any changes or prior to detecting/receiving the addition data 319.

FIG. 3B illustrates a method 350 for facilitating gathering of data and setting of expectations relating to an event at computing devices according to one embodiment. Method 350 may be performed by processing logic that may comprise hardware (e.g., circuitry, dedicated logic, programmable logic, etc.), software (such as instructions run on a processing device), or a combination thereof. In one embodiment, method 350 may be performed by event mechanism 110 of FIG. 1. The processes of method 350 are illustrated in linear sequences for brevity and clarity in presentation; however, it is contemplated that any number of them can be performed in parallel, asynchronously, or in different orders. For brevity, many of the details discussed with reference to FIGS. 1 and 2 may not be discussed or repeated hereafter.

Method 350 begins at block 351 with detecting, by a server computer, an invitation being received at a client computer from, for example, a third-party computer, such as from an event organizer's computer. As aforementioned with respect to FIGS. 2 and 3A, the invitation may be detected at the client computer or simply received at the server computer as communicated by the client computer. In one embodiment, the event and user's participation in the event may be inferred by monitoring the user's media feeds such that the user may not even need a formal invitation or make a specific request to receive recommendations from event mechanism 110 of FIG. 1. Similarly, in one embodiment, various invitation websites, such as Evite®, etc., may employ event mechanism 110 such that any recommendations (as well as all the logic behind various processes leading up to the recommendations) may occur, via event mechanism 110, prior to the announcement of the event in the first place with an average recommendation for all users.

At block 353, relevant data is extracted through any number of processes, such as one or more of primary data gathering or self-gathering (of websites, databases, etc.) secondary data gathering or user (computer) gathering, tertiary data gathering or extended (third-party computer) gathering, and receiving data via user inputs, etc., as described with reference to FIGS. 2 and 3A.

Upon having the relevant data, at block 355, the relevant data may then be interpreted for relevance using any number and type of relevancy and/or filtering factors as further described in FIG. 2 with reference to aggregation and interpretation engine 209. At block 357, event recommendations are generated based on the interpreted data as further described in FIG. 2 with reference to recommendation logic 215. At block 359, a determination is made as to whether any new additional (communication) data is received that may pertain to the recommendations as described with reference to FIGS. 2 and 3A. If no such additional data is received, at block 361, the recommendations are communicated to the user via the client computer over a network, such as cloud network, the Internet, etc. If additional data is received, the process continues at block 363 where the additional data is assessed and considered for further calibration or customization of the event recommendations and upon such assessment, if necessary, at 365, a proposal is communicated back to recommendation logic 215 of FIG. 2 to determine whether the recommendations are to be modified. If the proposal is accepted, the one or more corresponding recommendations are modified and re-calibrated into new or updated recommendations at block 357 and communicated to the user at block 361. If the proposal is rejected, the process may end or continue on with communication of the initial set of event recommendations at block 361.

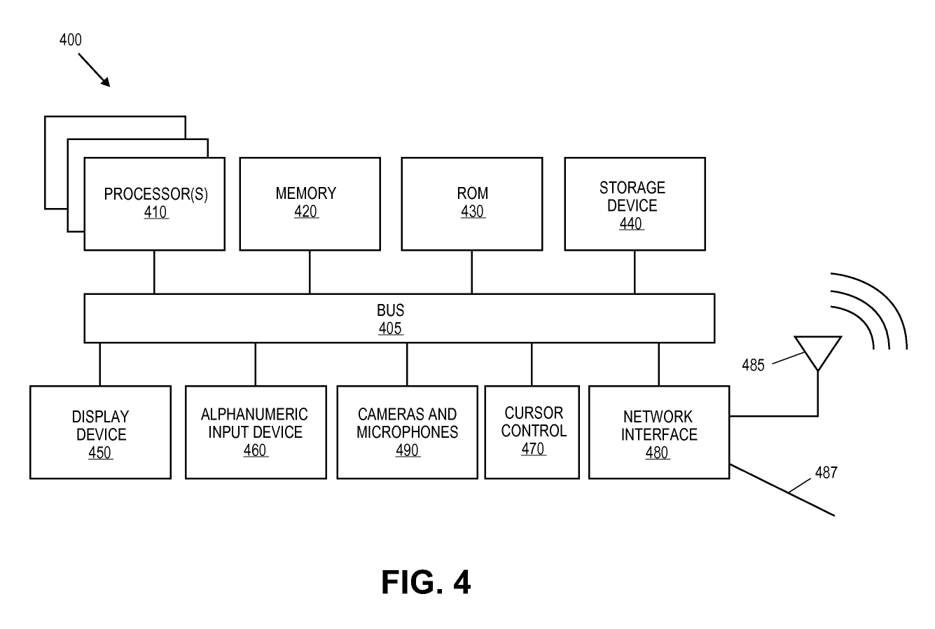

FIG. 4 illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components. Computing device 400 may be the same as or similar to or include computing devices 100, 200, 300 as described in reference to FIGS. 1, 2, 3A.

Computing system 400 includes bus 405 (or, for example, a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate data gathering and expectations setting, comprising: detection/reception logic to detect an invitation relating to an event, wherein the invitation includes an invitation to an invitee to attend the event; data gathering engine to obtain data relating to the event from a plurality of sources, wherein the data further relates to other invitees of the event; aggregation and interpretation engine to interpret the obtained data based on one or more of filtering factors and relevancy factors; recommendation logic to generate recommendations based on the interpreted data, wherein the recommendations include expectations relating to the event; and communication/configuration logic to facilitate communication of the recommendations to set the expectations for the invitee in anticipation of the event.

Example 2 includes the subject matter of Example 1, wherein the data gathering engine comprises: text extraction logic of the data gathering engine to access one or more of the plurality of sources to obtain textual features relating to the event, wherein the textual features include written information having one or more of articles, presentations, blogs, news items, and summaries; and media crawling logic of the data gathering engine to access one or more of the plurality of sources to obtain media features of the data, wherein the media features include one or more of photos, images, sketches, videos, and audios.

Example 3 includes the subject matter of Example 1, wherein the plurality of sources comprise one or more of official or unofficial event-related websites, blogs, newspaper websites, business network websites, social networking websites, venue websites, city or country websites, and hotel websites, one or more computing device having first information relating to the invitee, and one or more other computing devices having second information relating to one or more of the other invitees, wherein the first information is received by the detection/reception logic via one or more inputs provided by the invitee, wherein the first information includes user preferences relating to one or more of clothing, shoes, jewelry, style, and personalities.

Example 4 includes the subject matter of Example 1, wherein the aggregation and interpretation engine comprises: filtering logic to filter the obtained data based on one or more of the filtering factors, wherein the filtering factors relate to one or more of privacy, decency, legality, amount of data, and general relevancy; and relevancy logic to further filter the obtained data based on one or more of the relevancy factors, wherein the relevancy filters relate to one or more of date of the event, time of the event, weather for the event, context of the event, and one or more clothing factors including one or more of formal, informal, business-casual, style, and colors.

Example 5 includes the subject matter of Example 1, wherein the relevancy factors further relate to demographics of the invitees of the event or attendees of one or more previous events, wherein the demographics include one or more of age, gender, ethnicity, nationality, education level, income level, and professional category.

Example 6 includes the subject matter of Example 1, further comprising: streamlining/bootstrapping logic to generate a proposal to modify the recommendations based on new data, wherein the new data is obtained through real-time monitoring, via the streamlining/bootstrapping logic, of changes to one or more of the relevancy factors, preferences provided by the invitee, style or preferences of one or more personalities being followed by the invitee, vendor suggestions for products or services, and political changes at or near the venue of the event.

Example 7 includes the subject matter of Example 6, wherein the streamlining/bootstrapping logic is further configured to forward the proposal to the recommendation logic, wherein the recommendation logic is further to partially or fully accept the proposal or reject the proposal, wherein one or more of the recommendations are modified according to the proposal if the proposal is partially or fully accepted.

Example 8 includes the subject matter of Example 1, wherein the communication/configuration logic is further configured to facilitate communication of the recommendations to set the expectations for an event organizer in anticipation of the event.

Some embodiments pertain to Example 9 that includes a method for facilitating data gathering and expectations setting on computing devices, comprising: detecting an invitation relating to an event, wherein the invitation includes an invitation to an invitee to attend the event; obtaining data relating to the event from a plurality of sources, wherein the data further relates to other invitees of the event; interpreting the obtained data based on one or more of filtering factors and relevancy factors; generating recommendations based on the interpreted data, wherein the recommendations include expectations relating to the event; and facilitating communication of the recommendations to set the expectations for the invitee in anticipation of the event.

Example 10 includes the subject matter of Example 9, wherein obtaining the data comprises: accessing one or more of the plurality of sources to obtain textual features relating to the event, wherein the textual features include written information having one or more of articles, presentations, blogs, news items, and summaries; and accessing one or more of the plurality of sources to obtain media features of the data, wherein the media features include one or more of photos, images, sketches, videos, and audios.

Example 11 includes the subject matter of Example 9, wherein the plurality of sources comprise one or more of official or unofficial event-related websites, blogs, newspaper websites, business network websites, social networking websites, venue websites, city or country websites, and hotel websites, one or more computing device having first information relating to the invitee, and one or more other computing devices having second information relating to one or more of the other invitees, wherein the first information is received by the detection/reception logic via one or more inputs provided by the invitee, wherein the first information includes user preferences relating to one or more of clothing, shoes, jewelry, style, and personalities.

Example 12 includes the subject matter of Example 9, wherein interpreting the data comprises: filtering the obtained data based on one or more of the filtering factors, wherein the filtering factors relate to one or more of privacy, decency, legality, amount of data, and general relevancy; and filtering the obtained data based on one or more of the relevancy factors, wherein the relevancy filters relate to one or more of date of the event, time of the event, weather for the event, context of the event, and one or more clothing factors including one or more of formal, informal, business-casual, style, and colors.

Example 13 includes the subject matter of Example 9, wherein the relevancy factors further relate to demographics of the invitees of the event or attendees of one or more previous events, wherein the demographics include one or more of age, gender, ethnicity, nationality, education level, income level, and professional category.

Example 14 includes the subject matter of Example 9, further comprising: generating a proposal to modify the recommendations based on new data, wherein the new data is obtained through real-time monitoring of changes to one or more of the relevancy factors, preferences provided by the invitee, style or preferences of one or more personalities being followed by the invitee, vendor suggestions for products or services, and political changes at or near the venue of the event.

Example 15 includes the subject matter of Example 14, further comprising: partially or fully accepting the proposal or rejecting the proposal, wherein one or more of the recommendations are modified according to the proposal if the proposal is partially or fully accepted.

Example 16 includes the subject matter of Example 9, further comprising: facilitating communication of the recommendations to set the expectations for an event organizer in anticipation of the event.

Example 17 includes at least one machine-readable medium comprising a plurality of instructions, when executed on a computing device, to implement or perform a method or realize an apparatus as claimed in any preceding claims.

Example 18 includes at least one non-transitory or tangible machine-readable medium comprising a plurality of instructions, when executed on a computing device, to implement or perform a method or realize an apparatus as claimed in any preceding claims.

Example 19 includes a system comprising a mechanism to implement or perform a method or realize an apparatus as claimed in any preceding claims.

Example 20 includes an apparatus comprising means to perform a method as claimed in any preceding claims.

Example 21 includes a computing device arranged to implement or perform a method or realize an apparatus as claimed in any preceding claims.

Example 22 includes a communications device arranged to implement or perform a method or realize an apparatus as claimed in any preceding claims.

Some embodiments pertain to Example 23 includes a system comprising a storage device having instructions, and a processor to execute the instructions to facilitate a mechanism to perform one or more operations comprising: detecting an invitation relating to an event, wherein the invitation includes an invitation to an invitee to attend the event; obtaining data relating to the event from a plurality of sources, wherein the data further relates to other invitees of the event; interpreting the obtained data based on one or more of filtering factors and relevancy factors; generating recommendations based on the interpreted data, wherein the recommendations include expectations relating to the event; and facilitating communication of the recommendations to set the expectations for the invitee in anticipation of the event.

Example 24 includes the subject matter of Example 23, wherein the operations of obtaining the data comprises: accessing one or more of the plurality of sources to obtain textual features relating to the event, wherein the textual features include written information having one or more of articles, presentations, blogs, news items, and summaries; and accessing one or more of the plurality of sources to obtain media features of the data, wherein the media features include one or more of photos, images, sketches, videos, and audios.

Example 25 includes the subject matter of Example 23, wherein the plurality of sources comprise one or more of official or unofficial event-related websites, blogs, newspaper websites, business network websites, social networking websites, venue websites, city or country websites, and hotel websites, one or more computing device having first information relating to the invitee, and one or more other computing devices having second information relating to one or more of the other invitees, wherein the first information is received by the detection/reception logic via one or more inputs provided by the invitee, wherein the first information includes user preferences relating to one or more of clothing, shoes, jewelry, style, and personalities.

Example 26 includes the subject matter of Example 23, wherein the operation of interpreting the data comprises: filtering the obtained data based on one or more of the filtering factors, wherein the filtering factors relate to one or more of privacy, decency, legality, amount of data, and general relevancy; and filtering the obtained data based on one or more of the relevancy factors, wherein the relevancy filters relate to one or more of date of the event, time of the event, weather for the event, context of the event, and one or more clothing factors including one or more of formal, informal, business-casual, style, and colors.

Example 27 includes the subject matter of Example 23, wherein the relevancy factors further relate to demographics of the invitees of the event or attendees of one or more previous events, wherein the demographics include one or more of age, gender, ethnicity, nationality, education level, income level, and professional category.

Example 28 includes the subject matter of Example 23, wherein the one or more operations further comprise: generating a proposal to modify the recommendations based on new data, wherein the new data is obtained through real-time monitoring of changes to one or more of the relevancy factors, preferences provided by the invitee, style or preferences of one or more personalities being followed by the invitee, vendor suggestions for products or services, and political changes at or near the venue of the event.

Example 29 includes the subject matter of Example 28, wherein the one or more operations further comprise: partially or fully accepting the proposal or rejecting the proposal, wherein one or more of the recommendations are modified according to the proposal if the proposal is partially or fully accepted.

Example 30 includes the subject matter of Example 23, wherein the one or more operations further comprise: facilitating communication of the recommendations to set the expectations for an event organizer in anticipation of the event.

Some embodiments pertain to Example 31 includes an apparatus comprising: means for detecting an invitation relating to an event, wherein the invitation includes an invitation to an invitee to attend the event; means for obtaining data relating to the event from a plurality of sources, wherein the data further relates to other invitees of the event; means for interpreting the obtained data based on one or more of filtering factors and relevancy factors; means for generating recommendations based on the interpreted data, wherein the recommendations include expectations relating to the event; and means for facilitating communication of the recommendations to set the expectations for the invitee in anticipation of the event.

Example 32 includes the subject matter of Example 31, wherein the means for obtaining the data comprises: means for accessing one or more of the plurality of sources to obtain textual features relating to the event, wherein the textual features include written information having one or more of articles, presentations, blogs, news items, and summaries; and means for accessing one or more of the plurality of sources to obtain media features of the data, wherein the media features include one or more of photos, images, sketches, videos, and audios.

Example 33 includes the subject matter of Example 31, wherein the plurality of sources comprise one or more of official or unofficial event-related websites, blogs, newspaper websites, business network websites, social networking websites, venue websites, city or country websites, and hotel websites, one or more computing device having first information relating to the invitee, and one or more other computing devices having second information relating to one or more of the other invitees, wherein the first information is received by the detection/reception logic via one or more inputs provided by the invitee, wherein the first information includes user preferences relating to one or more of clothing, shoes, jewelry, style, and personalities.

Example 34 includes the subject matter of Example 31, wherein the means for interpreting the data comprises: means for filtering the obtained data based on one or more of the filtering factors, wherein the filtering factors relate to one or more of privacy, decency, legality, amount of data, and general relevancy; and means for filtering the obtained data based on one or more of the relevancy factors, wherein the relevancy filters relate to one or more of date of the event, time of the event, weather for the event, context of the event, and one or more clothing factors including one or more of formal, informal, business-casual, style, and colors.

Example 35 includes the subject matter of Example 31, wherein the relevancy factors further relate to demographics of the invitees of the event or attendees of one or more previous events, wherein the demographics include one or more of age, gender, ethnicity, nationality, education level, income level, and professional category.

Example 36 includes the subject matter of Example 31, further comprising: means for generating a proposal to modify the recommendations based on new data, wherein the new data is obtained through real-time monitoring of changes to one or more of the relevancy factors, preferences provided by the invitee, style or preferences of one or more personalities being followed by the invitee, vendor suggestions for products or services, and political changes at or near the venue of the event.

Example 37 includes the subject matter of Example 36, further comprising: means for partially or fully accepting the proposal or rejecting the proposal, wherein one or more of the recommendations are modified according to the proposal if the proposal is partially or fully accepted.

Example 38 includes the subject matter of Example 31, further comprising: means for facilitating communication of the recommendations to set the expectations for an event organizer in anticipation of the event.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection/reception logic to detect an invitation relating to an event, wherein the invitation includes an invitation to an invitee to attend the event;
data gathering engine to obtain data relating to the event from a plurality of sources, wherein the data further relates to other invitees of the event;
aggregation and interpretation engine to interpret the obtained data based on one or more of filtering factors and relevancy factors;
recommendation logic to generate recommendations based on the interpreted data, wherein the recommendations include expectations relating to the event; and
communication/configuration logic to facilitate communication of the recommendations to set the expectations for the invitee in anticipation of the event.

2. The apparatus of claim 1, wherein the data gathering engine comprises:
text extraction logic of the data gathering engine to access one or more of the plurality of sources to obtain textual features relating to the event, wherein the textual features include written information having one or more of articles, presentations, blogs, news items, and summaries; and
media crawling logic of the data gathering engine to access one or more of the plurality of sources to obtain media features of the data, wherein the media features include one or more of photos, images, sketches, videos, and audios.

3. The apparatus of claim 1, wherein the plurality of sources comprise one or more of official or unofficial event-related websites, blogs, newspaper websites, business network websites, social networking websites, venue websites, city or country websites, and hotel websites, one or more computing device having first information relating to the invitee, and one or more other computing devices having second information relating to one or more of the other invitees, wherein the first information is received by the detection/reception logic via one or more inputs provided by the invitee, wherein the first information includes user preferences relating to one or more of clothing, shoes, jewelry, style, and personalities.

4. The apparatus of claim 1, wherein the aggregation and interpretation engine comprises:
filtering logic to filter the obtained data based on one or more of the filtering factors, wherein the filtering factors relate to one or more of privacy, decency, legality, amount of data, and general relevancy; and
relevancy logic to further filter the obtained data based on one or more of the relevancy factors, wherein the relevancy filters relate to one or more of date of the event, time of the event, weather for the event, context of the event, and one or more clothing factors including one or more of formal, informal, business-casual, style, and colors.

5. The apparatus of claim 1, wherein the relevancy factors further relate to demographics of the invitees of the event or attendees of one or more previous events, wherein the demographics include one or more of age, gender, ethnicity, nationality, education level, income level, and professional category.

6. The apparatus of claim 1, further comprising:
streamlining/bootstrapping logic to generate a proposal to modify the recommendations based on new data, wherein the new data is obtained through real-time monitoring, via the streamlining/bootstrapping logic, of changes to one or more of the relevancy factors, preferences provided by the invitee, style or preferences of one or more personalities being followed by the invitee, vendor suggestions for products or services, and political changes at or near the venue of the event.

7. The apparatus of claim 6, wherein the streamlining/bootstrapping logic is further configured to forward the proposal to the recommendation logic, wherein the recommendation logic is further to partially or fully accept the proposal or reject the proposal, wherein one or more of the recommendations are modified according to the proposal if the proposal is partially or fully accepted.

8. The apparatus of claim 1, wherein the communication/configuration logic is further configured to facilitate communication of the recommendations to set the expectations for an event organizer in anticipation of the event.

9. A method comprising:
detecting an invitation relating to an event, wherein the invitation includes an invitation to an invitee to attend the event;
obtaining data relating to the event from a plurality of sources, wherein the data further relates to other invitees of the event;
interpreting the obtained data based on one or more of filtering factors and relevancy factors;
generating recommendations based on the interpreted data, wherein the recommendations include expectations relating to the event; and
facilitating communication of the recommendations to set the expectations for the invitee in anticipation of the event.

10. The method of claim 9, wherein obtaining the data comprises:
accessing one or more of the plurality of sources to obtain textual features relating to the event, wherein the textual features include written information having one or more of articles, presentations, blogs, news items, and summaries; and
accessing one or more of the plurality of sources to obtain media features of the data, wherein the media features include one or more of photos, images, sketches, videos, and audios.

11. The method of claim 9, wherein the plurality of sources comprise one or more of official or unofficial event-related websites, blogs, newspaper websites, business network websites, social networking websites, venue websites, city or country websites, and hotel websites, one or more computing device having first information relating to the invitee, and one or more other computing devices having second information relating to one or more of the other invitees, wherein the first information is received by the detection/reception logic via one or more inputs provided by the invitee, wherein the first information includes user preferences relating to one or more of clothing, shoes, jewelry, style, and personalities.

12. The method of claim 9, wherein interpreting the data comprises:
filtering the obtained data based on one or more of the filtering factors, wherein the filtering factors relate to one or more of privacy, decency, legality, amount of data, and general relevancy; and
filtering the obtained data based on one or more of the relevancy factors, wherein the relevancy filters relate to one or more of date of the event, time of the event, weather for the event, context of the event, and one or more clothing factors including one or more of formal, informal, business-casual, style, and colors.

13. The method of claim 9, wherein the relevancy factors further relate to demographics of the invitees of the event or attendees of one or more previous events, wherein the demographics include one or more of age, gender, ethnicity, nationality, education level, income level, and professional category.

14. The method of claim 9, further comprising:
generating a proposal to modify the recommendations based on new data, wherein the new data is obtained through real-time monitoring of changes to one or more of the relevancy factors, preferences provided by the invitee, style or preferences of one or more personalities being followed by the invitee, vendor suggestions for products or services, and political changes at or near the venue of the event.

15. The method of claim 14, further comprising:
partially or fully accepting the proposal or rejecting the proposal, wherein one or more of the recommendations are modified according to the proposal if the proposal is partially or fully accepted.

16. The method of claim 9, further comprising:
facilitating communication of the recommendations to set the expectations for an event organizer in anticipation of the event.

17. At least one machine-readable medium comprising a plurality of instructions, executed on a computing device, to facilitate the computing device to perform one or more operations comprising:
detecting an invitation relating to an event, wherein the invitation includes an invitation to an invitee to attend the event;
obtaining data relating to the event from a plurality of sources, wherein the data further relates to other invitees of the event;
interpreting the obtained data based on one or more of filtering factors and relevancy factors;
generating recommendations based on the interpreted data, wherein the recommendations include expectations relating to the event; and
facilitating communication of the recommendations to set the expectations for the invitee in anticipation of the event.

18. The machine-readable medium of claim 17, wherein the operations of obtaining the data comprises:
accessing one or more of the plurality of sources to obtain textual features relating to the event, wherein the textual features include written information having one or more of articles, presentations, blogs, news items, and summaries; and
accessing one or more of the plurality of sources to obtain media features of the data, wherein the media features include one or more of photos, images, sketches, videos, and audios.

19. The machine-readable medium of claim 17, wherein the plurality of sources comprise one or more of official or unofficial event-related websites, blogs, newspaper websites, business network websites, social networking websites, venue websites, city or country websites, and hotel websites, one or more computing device having first information relating to the invitee, and one or more other computing devices having second information relating to one or more of the other invitees, wherein the first information is received by the detection/reception logic via one or more inputs provided by the invitee, wherein the first information includes user preferences relating to one or more of clothing, shoes, jewelry, style, and personalities.

20. The machine-readable medium of claim 17, wherein the operations of interpreting the data comprises:
filtering the obtained data based on one or more of the filtering factors, wherein the filtering factors relate to one or more of privacy, decency, legality, amount of data, and general relevancy; and
filtering the obtained data based on one or more of the relevancy factors, wherein the relevancy filters relate to one or more of date of the event, time of the event, weather for the event, context of the event, and one or more clothing factors including one or more of formal, informal, business-casual, style, and colors.

21. The machine-readable medium of claim 17, wherein the relevancy factors further relate to demographics of the invitees of the event or attendees of one or more previous events, wherein the demographics include one or more of age, gender, ethnicity, nationality, education level, income level, and professional category.

22. The machine-readable medium of claim 17, wherein the one or more operations comprise:
generating a proposal to modify the recommendations based on new data, wherein the new data is obtained through real-time monitoring of changes to one or more of the relevancy factors, preferences provided by the invitee, style or preferences of one or more personalities being followed by the invitee, vendor suggestions for products or services, and political changes at or near the venue of the event.

23. The machine-readable medium of claim 22, wherein the one or more operations comprise:
partially or fully accepting the proposal or rejecting the proposal, wherein one or more of the recommendations are modified according to the proposal if the proposal is partially or fully accepted.

24. The machine-readable medium of claim 17, wherein the one or more operations comprise:
facilitating communication of the recommendations to set the expectations for an event organizer in anticipation of the event.
